(19) United States
(12) Patent Application Publication
(10) Pub. No.: US 2006/0076698 A1
(43) Pub. Date: Apr. 13, 2006

(54) Method for making dental prosthesis or dental prosthesis base material

(76) Inventor: David Alan Hamlin, Langhorne, PA (US)

Correspondence Address: Mr. David Alan Hamilton, 15 Parkside Drive, Langhorne, PA, 19047, US

(21) Appl. No.: 10/961,023

(22) Filed: Oct. 12, 2004

(51) Int. Cl. A61C 13/20; A61C 13/08; H05B 6/64; C04B 35/653

(52) U.S. Cl. 264/16; 264/17; 264/19; 264/460; 264/489; 65/17.3; 264/332

(57) ABSTRACT

A dental prosthesis, such as a crown, a bridge, inlay, onlay, a laminate veneer or an artificial tooth, or a dental prosthesis base material, such as an abutment, an abutment having a post, or a post, is made with a low cost in a short time by using dental glass ionomer cement, which is excellent in cost, mechanical strength and biocompatibility and has fluorine sustained releasability in general, by a method comprising steps of enclosing a mixture of dental glass ionomer cement into a mold in a shape fitting to the dental prosthesis or the dental prosthesis base material to be made, putting the mold into water, irradiating the whole mold with a microwave, and curing the dental glass ionomer cement in a short time, thereby a conventional problem of slow curing reaction in dental glass ionomer cement is solved.

### BACKGROUND OF THE INVENTION

1. Field of the Invention

The present invention relates to a method for making a dental prosthesis or a dental prosthesis base material, wherein the dental prosthesis or the dental prosthesis base material can be made quickly by using a low-cost dental glass ionomer cement.

2. Description of the Conventional Art

Conventionally, when a tooth is damaged or a part of tooth is lost, a following treating method is widely carried out. The method comprises steps of forming an abutment, such as an abutment tooth or the like, at a in the oral cavity of a patient, making a dental prosthesis out of an oral cavity impression, and adhering and fixing the prosthesis on the abutment. The dental prosthesis adhered and fixed on the abutment is called as a crown or a bridge, and has a form of a tooth. At this time, in the case of requiring aesthetic appreciation approximating to a natural tooth, such a dental prosthesis as a resin faced cast crown, a porcelain baked faced cast crown, a resin faced bridge, a porcelain baked bridge, an all ceramic crown or the like is used.

In the case of the resin faced cast crown, the resin faced bridge, the porcelain-baked faced cast crown and the porcelain baked bridge, these are made by a lost wax casting method, which comprises steps of making a wax pattern of a core part by wax on a gypsum model made by an impression taking, investing the wax pattern in a refractory investment material to harden the refractory investment material, heating the refractory investment material in an electric furnace, burning the wax pattern to obtain the mould, casting a metal in the mold, digging up the cast material from the refractory investment material, cutting and polishing the cast material to make a metal core part, and building up and polymerizing a hard resin for a crown or building up and baking a porcelain on the outer surface of the metal core part. Further, in the case of the all ceramic crown, it is made by steps of making a double model using a refractory modeling material, building up and baking the porcelain on said double model, removing a refractory double model, carrying out a shape correction and polishing.

Moreover, when a dental caries is diagnosed on a tooth, a following treating method is widely used. The method comprises steps of forming a prepared cavity by removing carious dentin and enamel, making a dental prosthesis out of an oral cavity by the same process as that of the lost wax method, and adhering and fixing the dental prosthesis within the prepared cavity. The dental prosthesis adhered and fixed at the cavity is called as inlay or onlay, and has a shape fitting to the cavity and replacing lost tooth structure to return the treated tooth to form and function of a non-affected tooth. At this time, in the case of achieving a more natural looking replacement approximating to a natural tooth, the dental prosthesis made of a ceramic or a composite resin.

However, in the cases of the metallic dental prosthesis, the ceramic inlay and the all-ceramic crown, there is an added requirement that the restorations mentioned above require significant laboratory effort to construct the dental prosthesis. Further, in the case of the dental composite resin, there are problems that an unpolymerized monomer remains, and the unit cost of the base product is high.

As the method for making the dental prosthesis more easily, there is a method of attaching a polypropylene material or the like which is made in a shape of the tooth surface beforehand to the abutment of the abutment tooth, by using a dental cement or a dental composite resin. However, this method is limited to a temporally usage since having the problems in aesthetic appearance and durability. Further, there is another method comprising steps of making the dental prosthesis having a shape of a part of the tooth surface or a total surface of the tooth, beforehand with a hard resin material instead of the material such as polypropylene or the like, and adhering the dental prosthesis at the abutment of the abutment tooth by using the dental resin material such as the dental composite resin or the like (for example, referring to Japanese Patents Laid Open No. 2004-65578 and No. 2004-65579). However, there is also a problem that the cost of one treatment is high since a usage amount of the dental resin material is large.

As a material for making the dental prosthesis having the shape of a part of the tooth surface or the total surface of the tooth, it can be considered to use a conventional type dental cement, which is the most excellent material in the point of safely and cost since it does not contain a monomer component and a unit cost of a product is low. However, as for the dental cement, there are some problems that a long treatment time is required since its hardening reaction (for example, a chemical reaction of an acid and a base) is slow as compared with a polymerization reaction of the resin material, and sufficient care is required not to apply an excessive force to the restored part immediately after the treatment. Especially, when the dental prosthesis is directly exposed on the uppermost surface in an oral cavity as a substitute for the tooth surface, there is a problem of the dental prosthesis being possibly damaged as occlusal forces are factored in.

### SUMMARY OF THE INVENTION

Then, the present invention has an object to provide the method for making the dental prosthesis or the dental prosthesis base material with a low cost in a short time, by using the dental cement, especially, a dental glass ionomer cement, instead of the expensive dental resin material, and solving the conventional fault of the dental glass ionomer cement that the hardening reaction is slow. The dental glass ionomer cement has an excellent unit cost of a product, mechanical strength, and biocompatibility, and the cement has fluorine sustained releasability when an aluminosilicate glass powder is a fluoroaluminosilicate glass powder.

The earnest work was carried out in order to solve the above-mentioned problems and, as the result, the following was found out. A dental glass monomer cement before hardening, that is, a mixed and kneaded product of the aluminosilicate glass powder, a polycarboxylic acid and water, is enclosed in a mold which is made to have a shape fitting to the dental prosthesis or the dental prosthesis base material to be made. The mold is put in water bath. When the whole mold is irradiated by a microwave in water, the water in the mixture and surround of the mold is heated by the microwave. When only the mixture is irradiated by the microwave, the mixture is rapidly heated so that the quality of the cement may be damaged. On the other hand, when the whole mold is irradiated by the microwave in water, the heat is not generated rapidly but generated gradually by the water surrounding the mold and induces the hardening reaction of cement remarkably rapidly. Then, the investigation was completed.

Thus, the present invention relates to a method for making a dental prosthesis or a dental prosthesis base material, the method comprising steps of enclosing a mixture of a dental glass ionomer cement into a mold which is made to have a shape generally fitting to the dental prosthesis or the dental prosthesis base material to be made, separating the mold and partially set glass ionomer cement from the tooth or model of the tooth, putting the mold containing the partially set glass ionomer cement into water, and irradiating the whole mold and partially set glass ionomer cement with a microwave.

As the dental glass ionomer cement used in the method for making the dental prosthesis or the dental prosthesis base material according to the present invention, the following cements can be preferably used. Those are a cement comprising a fluoroaluminosilicate glass powder, a polycarboxylic acid and water, a cement comprising a fluoroaluminosilicate glass powder, a polycarboxylic acid, a metal powder and water, and a cement comprising a fluoroaluminosilicate glass powder, a polycarboxylic acid, a polymerization catalyst, a polymerizable monomer and water.

Further, in the method for making the dental prosthesis or the dental prosthesis base material, the dental prosthesis to be made is any one of a crown, a bridge, inlay, onlay, a laminate veneer and an artificial tooth, and the dental prosthesis base material to be made is any one of an abutment part, an abutment part having a post and a post.

As the method for making the dental prosthesis or the dental prosthesis base material according to the present invention, the following ways are used when the making of the dental prosthesis or the dental prosthesis base material is necessary because the tooth is damaged or lost, or the dental caries is generated. One comprises steps of making a gypsum model made by an impression taking, making a wax pattern of a core part on the gypsum model by using a wax, making a mold fitting to the wax pattern with a gypsum or a plastic, enclosing the mixture of the dental glass ionomer cement into the mold, putting the mold and partially set glass ionomer cement into water, and irradiating the whole mold and partially set glass ionomer cement by the microwave, thereby the dental prosthesis or the dental prosthesis base material fitting to a treating part of a patient being made from the glass ionomer cement. Another comprises steps of enclosing the mixture of the dental glass ionomer cement into a mold made to have a shape defined beforehand, as shown in Japanese Patents Laid Open No. 2004-65578 and No. 2004-65579, putting the mold into water, and irradiating the whole mold by the microwave in water, thereby the dental prosthesis or the dental prosthesis base material approximating to a general shape of a tooth being made. The former is suitable to the case of making the dental prosthesis or the dental prosthesis base material as a single item in a shape fitting to the treating part of a patient. The later is suitable to the case of making the general dental prosthesis or dental prosthesis base material as a single item in a dental clinic or the like according to the necessity, or the case of making a large amount of the general dental prosthesis or dental prosthesis base material in a factory.

In both the cases, the dental glass ionomer cement hardens in a short time compared to the standard time needed to fully set a glass ionomer cement, so that the dental prosthesis or the dental prosthesis base material can be made timely and easily with a low cost.

### BRIEF EXPLANATION OF DRAWINGS

FIG. 1 is a cross sectional explanatory view showing one example in the case that a crown is made as the dental prosthesis by the method for making the dental prosthesis or the dental prosthesis base material according to the present invention.

FIG. 2 is a cross sectional explanatory view showing one example in the case that a laminate veneer is made as the dental prosthesis by the method for making the dental prosthesis or the dental prosthesis base material according to the present invention.

FIG. 3 is a cross sectional explanatory view showing one example in the case that an artificial tooth for mounting on the abutment tooth is made as the dental prosthesis by the method for making the dental prosthesis or the dental prosthesis base material according to the present invention.

FIG. 4 is a cross sectional explanatory view showing one example in the case that an abutment part having a post is made as the dental prosthesis by the method for making the dental prosthesis or the dental prosthesis base material according to the present invention.

### DETAILED DESCRIPTION OF PREFERRED EMBODIMENT

The dental glass ionomer cement used in the present invention indicates all cements having such a mechanism that the aluminosilicate glass powder and the polycarboxylic acid are hardened by the hardening reaction (that is, an ionomer reaction) under existence of water. The dental glass ionomer cement includes a conventional type dental glass ionomer cement which does not contain the polymerizable monomer and is hardened by only the ionomer reaction, a dental glass ionomer cement for a base which is made by adding a metallic powder to the conventional type dental glass ionomer cement, a resin reinforced type dental glass ionomer cement which is made by blending the polymerization catalyst and the polymerizable monomer with the conventional type dental glass ionomer cement, or the like. Further, the mixture of the aluminosilicate glass powder, the polycarboxylic acid and water becomes a one paste finally. However, as for a property of the dental glass ionomer cement before mixing, the property of the conventional dental glass ionomer cement, such as powder, liquid, two or more pastes, can be used without limitation.

As the aluminosilicate glass powder used in the general dental glass ionomer cement, the fluoroaluminosilicate glass powder, which is conventionally used for the dental glass ionomer cement, can be preferably used since having the fluorine sustained releasability. Among others, a powder having a 0.02 to 20 μm average particle size, which is made by mixing and melting a raw material containing 10 to 25% of Al³⁺ by weight, 5 to 30% of Si⁴⁺ by weight, 1 to 30% of F⁻ by weight, 0 to 20% of Sr²⁺ by weight, 0 to 20% of Ca²⁺ by weight, and a 0 to 10% of alkaline metal ion (Na⁺, K⁺ or the like) by weight, to the total weights of the glass, and then cooling and pulverizing the mixture, is most preferable since having the high mechanical strength and the excellent reactivity.

The polycarboxylic acid is a polymer of a α-β unsaturated monocarboxylic acid or a α-β unsaturated dicarboxylic acid, and conventionally used for the dental glass ionomer cement. In general, the polycarboxylic acid is a copolymer or a homopolymer of acrylic acid, methacrylic acid, 2-chloroacrylic acid, 3-chloroacrylic acid, aconitic acid, mesaconic acid, maleic acid, itaconic acid, fumaric acid, glutaconic acid, citraconic acid, or the like. These coplymers or homopolymers have 5,000 to 40,000 weight average molecular weights. Furthermore, the commonly known agents such as a viscous agent, a polymerization inhibitor, an ultraviolet absorber, a plasticizer, a coloring pigment, an antioxidant, an antibacterial agent, a surfactant or the like may be added according to necessity to the dental glass ionomer cement used in the present invention.

As for the microwave to be irradiated, a microwave (2.45 GHz) obtained from a conventional household or professional microwave oven can be preferably used since it can be easily used. An irradiation time of the microwave cannot be completely specified since it is changed with an output of the microwave, a size or shape of the dental prosthesis to be made, a size of a container for putting the mold in, the volume of water put into the container, and a shape of the container. However, for example, in the case that water is put into a cylindrical container having a diameter of 3 cm and a height of 6 cm by a half, when the irradiation time of the microwave of 600 W output is generally about 30 seconds to 1 minute, or until a hardening reaction can be sufficiently carried out.

The embodiment of the method for making the dental prosthesis or the dental prosthesis base material according to the present invention is explained with drawings.

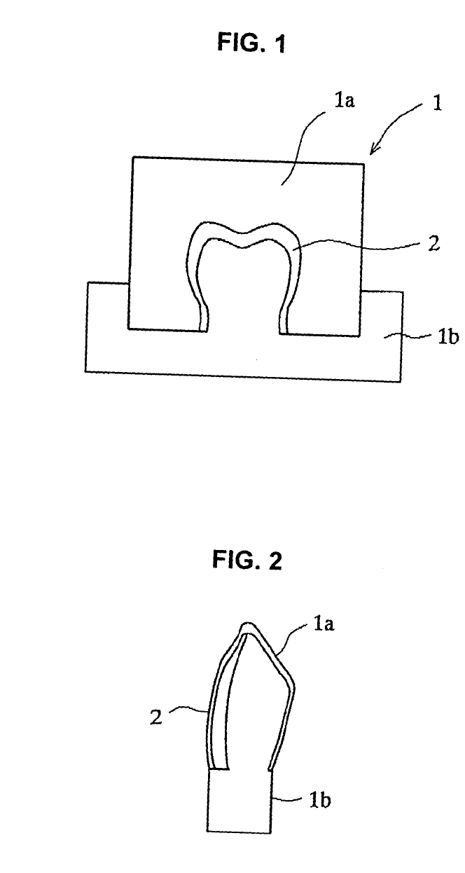

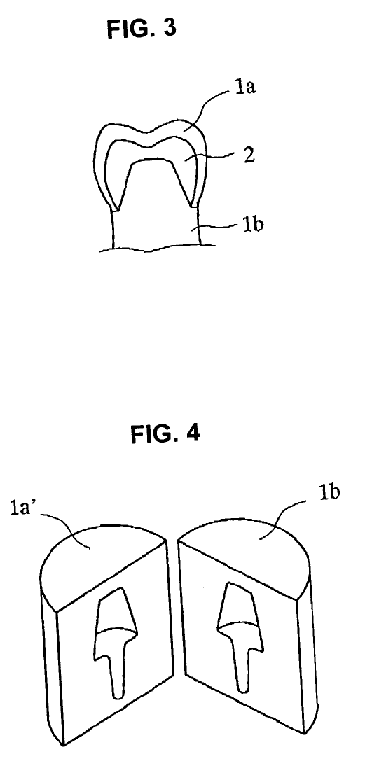

FIG. 1 is a cross sectional explanatory view showing one example in the case that a crown is made as the dental prosthesis by the method for making the dental prosthesis or the dental prosthesis base material according to the present invention. FIG. 2 is a cross sectional explanatory view showing one example in the case that a laminate veneer is made as the dental prosthesis by the method for making the dental prosthesis or the dental prosthesis base material according to the present invention. FIG. 3 is a cross sectional explanatory view showing one example in the case that an artificial tooth for mounting on the abutment tooth is made as the dental prosthesis by the method for making the dental prosthesis or the dental prosthesis base material according to the present invention. FIG. 4 is a cross sectional explanatory view showing one example in the case that an abutment part having a post is made as the dental prosthesis by the method for making the dental prosthesis or the dental prosthesis base material according to the present invention.

In the drawings, a numeral 1 is a mold made to have a shape fitting to the dental prosthesis or the dental prosthesis base material to be made. The mold is constituted of two dividable members 1a and 1b in general. However, when the dental prosthesis or the dental prosthesis base material to be made has such a shape as can be easily taken out from the inside of a mold 1 constituted of one member, the mold 1 may be constituted of one member and an opening part of the mold 1 is closed with a thin film for moisture proof, such as a polypropylene sheet or the like. As for a material of the mold 1, the gypsum or the plastic, which can transmit the irradiated microwave, is preferably used.

When the material of the mold 1 is the gypsum, the dental prosthesis or the dental prosthesis base material can be made with sufficient accuracy, so that it is preferable.

The plastic used for the material of the mold 1 may be an olefin-based polymer, such as polypropylene, polyethylene, polybutylene or the like, or its copolymer, an acrylic-based polymer, such as poly(meth)acrylic acid or the like represented with polymethylmethacrylate, or its copolymer, a styrene-based polymer, such as polystyrene, poly (acrylonitrile-styrene), poly(butadiene-styrene), ABS polymer or the like, a vinyl-based polymer, such as polyvinyl acetate, polyvinyl chloride, polyvinylidene chloride, polychlorinated vinyl chloride or the like, or its copolymer, an amide-based polymer, such as nylon 6, nylon 66, nylon 610, nylon 612, nylon 11, nylon 12, nylon 46 or the like, an unsaturated polyester resin, such as polyethylene terephthalate or the like, a fluorine-based polymer, such as polytetrafluoroethylene, polytrifluoro ethylene, polyvinylidene fluoride or the like, or its copolymer, and further, polycarbonate, polyacetal, polyether sulfone, polyphenylene oxide, polyphenylene sulfite, polysulfone or its copolymer, or the like.

A numeral 2 is a mixture made by mixing and kneading a dental glass ionomer cement to be enclosed into the mold 1. The dental glass ionomer cement may be, as mentioned above, the conventional type dental glass ionomer cement, the dental glass ionomer cement for a base, which is made by adding the metallic powder to the conventional type dental glass ionomer cement, the resin reinforced type dental glass ionomer cement, which is made by blending the polymerization catalyst and the polymerizable monomer with the conventional type dental glass ionomer cement, or the like. As the aluminosilicate glass powder used for these dental glass ionomer cements, the fluoroaluminosilicate glass powder is preferable since having the fluorine sustained releasability.

The method for making the dental prosthesis or the dental prosthesis base material according to the present invention can be carried out by the following process. First, the mixture 2 made by mixing and kneading the dental glass ionomer cement is enclosed into the mold 1 made to have the shape fitting to the dental prosthesis or the dental prosthesis base material to be made. When the mold 1 is constituted of one member having a recessed part, the thin film for moisture proof, such as a sheet made of polypropylene or the like, is attached over the recessed part to prevent water to contact with the mixture 2 filled in the recessed part. Further, when the mold 1 is constituted of two dividable members 1a and 1b, the thin film for moisture proof, such as a sheet made of polypropylene or the like, is preferably attached on the outer periphery of a connection part between the two members 1a and 1b. To prevent water to enter into the enclosed mixture 2 from a space of the connection part of the two members 1a and 1b. Then, the mold is put into water, and the whole mold is irradiated with the microwave to harden the dental glass ionomer cement by using the microwave oven for a generally low number of minutes (about 1 to 2 minutes if the dental prosthesis has a general size). Then, the mold and the fully set glass ionomer prosthesis 1 is taken out of the water.

At this time, a crown can be made as the dental prosthesis as shown in FIG. 1, when a shape of the inner periphery of one member 1a is the same as the surface shape of the dental prosthesis to be made, and a shape of a projection part provided at another member 1b is the same as the surface shape of the abutment tooth of a patient before mounting the dental prosthesis.

Furthermore, the crown type prosthesis as indicated in Japanese Patent Laid Open No. 2004-65578 can be made, when a shape of the inner periphery of one member 1a is the surface shape of the general tooth, and a shape of the projection part provided at another member 1b is sufficiently larger than the abutment being generally formed.

Furthermore, a laminate veneer can be made as the dental prosthesis as shown in FIG. 2 when a shape provided at the inner periphery of one member 1a is the same as the surface shape of the dental prosthesis to be made and a shape of the projection part provided at another member 1b is the same as the surface shape of the tooth, which is thinly cut off at the cheek side, of a patient before mounting the dental prosthesis.

Furthermore, the prosthesis for tooth surface as indicated in Japanese Patent Laid Open No. 2004-65579 can be made, when a shape of the inner periphery of one member 1a is a surface shape made by following the labial side of a front tooth, the cheek side, the adjacent sides or the occluding side of a molar tooth, or the cheek side or the adjacent sides and the occluding side of a molar tooth, and a shape of the projection part provided at another member 1b is sufficiently larger than an abutment being generally formed.

Furthermore, an artificial tooth as the dental prosthesis adhered and fixed at the abutment of the abutment tooth of a patient can be made as shown in FIG. 3, when a thin plastic, such as a polypropylene material or the like, with a shape of the inner periphery being approximately same as the surface shape of the dental prosthesis to be made, is used as one member 1a and a shape of the projection part provided at another member 1b is the shape of the abutment of the tooth of a patient before mounting the dental prosthesis. In this case, one member 1a comprising the thin plastic such as the polypropylene material or the like and having the shape of the inner periphery approximately same as the surface shape of the dental prosthesis to be made, can be mounted in the oral cavity without detaching it. When the artificial tooth is used in this way, a part for reinforcing the fixation, such as an undercut or the like, is preferably provided at the member 1b side, for preventing one member 1a of the mold 1 to separate from the hardened dental glass ionomer cement.

Furthermore, an abutment part having a post as the dental prosthesis base material can be made as shown in FIG. 4, when a shape of the inner periphery formed by one member 1a and another member 1b is a shape of a general abutment part having a post.

In this embodiment, only the abutment part as the dental prosthesis can be made, where the post part is removed, and only the post part as the dental prosthesis can be also made, where the abutment part is removed.

Then, when various dental prosthesis or dental prosthesis base materials shown in the above are made by the method for making the dental prosthesis or the dental prosthesis base material according to the present invention, the following process is carried out. As mentioned above, when the mold 1 is constituted of one member having the recessed part and made to have the shape fitting to the dental prosthesis or the dental prosthesis base material, the mixture 2 made by mixing and kneading the dental glass ionomer cement is filled in the recessed part. Then, the thin film for moisture proof, such as the polypropylene sheet or the like, is attached over the recessed part for preventing water to contact with the mixture 2 filled in the recessed part. Further, when the mold 1 is constituted of the dividable two members 1a and 1b, the thin film for moisture proof, such as the sheet made of polypropylene or the like, is preferably attached over the outer periphery of the connection part between the two members 1a and 1b, for preventing water to enter into the mixture 2 from the space of the connection part of the two members 1a and 1b, after the mixture 2 is filled in the mold 1 made to have the shape fitting to the dental prosthesis or the dental prosthesis base material to be made. Thereafter, the mold is put into water, and the whole mold is irradiated with microwave by using a microwave oven for a generally low number of minutes (about 1 to 2 minutes if the dental prosthesis has a general size). Thereby, the dental glass ionomer cement is hardened completely. The hardened dental glass ionomer cement prosthesis is then taken out from the water and mold, and thus the dental prosthesis or the dental prosthesis base material can be easily made in a short time with a low cost requiring no further processing before cementation into the mouth of the patient.

What is claimed is:

1. A method for making a dental prosthesis or a dental prosthesis base material, the method comprising steps of,
enclosing a mixture of a dental glass ionomer cement into a mold made to have a shape fitting to the dental prosthesis or the dental prosthesis base material to be made,
putting the mold into water, and
irradiating the whole mold with a microwave.

2. The method for making the dental prosthesis or the dental prosthesis base material according to claim 1, wherein the dental glass ionomer cement comprises a fluoroaluminosilicate glass powder, a polycarboxylic acid, and water.

3. The method for making the dental prosthesis or the dental prosthesis base material according to claim 1, wherein the dental glass ionomer cement comprises a fluoroaluminosilicate glass powder, a polycarboxylic acid, a metal powder and water.

4. The method for making the dental prosthesis or the dental prosthesis base material according to claim 1, wherein the dental glass ionomer cement comprises a fluoroaluminosilicate glass powder, a polycarboxylic acid, a polymerization catalyst, a polymerizable monomer and water.

5. The method for making the dental prosthesis or the dental prosthesis base material according to claim 1, wherein the dental prosthesis to be made is any one of a crown, a bridge, inlay, onlay, a laminate veneer and an artificial tooth.

6. The method for making the dental prosthesis or the dental prosthesis base material according to claim 1, wherein the dental prosthesis base material to be made is any one of an abutment, an abutment having a post and a post.

7. The method for making an indirect dental labial veneer according to claim 5 wherein the dental prosthesis base material to be made is shaped by a mold formed over a waxed projection of the desired outcome of shape and size of each tooth to be treated.

8. A glass ionomer prosthesis in which a homogeneous mix of components, placed into a dental mold, allowed to partially set, immersed into water, exposed to microwave until fully set, has the appearance of a heterogeneous structure in which the outer surface, protected by the mold, is smooth and uniform, and the inner surface not protected by the mold is rough, crystalline, and retentive to cement.
